(19) United States
(12) Patent Application Publication
(10) Pub. No.: US 2008/0232477 A1
(43) Pub. Date: Sep. 25, 2008

(54) Method and Device For Coding and Decoding of Video Error Resilience

(75) Inventors: Jin Wang, Shanghai (CN); Xin Chen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,827

(22) PCT Filed: Aug. 28, 2006
(86) PCT No.: PCT/IB2006/052969

§ 371 Date: Feb. 26, 2008

(30) Foreign Application Priority Data
Sep. 1, 2005 (CN) 200510097871.0

(51) Int. Cl. H04N 7/26; H04N 7/68

(52) U.S. Cl. 375/240.24; 375/240.27; 375/E07.2; 375/E07.281

(57) ABSTRACT

The invention provides a coding/decoding method and device for video error resilience, the coding method includes the step of: acquiring a macroblock-based object ID information (S120-S160) , wherein, the object ID information is used to identify an object in which the macroblock locates; coding the object ID information into a coded video stream (S170), wherein, the coded video stream includes the macroblock. The decoding method includes the step of: determining a substituting macroblock (S450) according to object ID information of a missing macroblock in video stream (S430-S440); replacing the missing macroblock by the determined macroblock (S460). The invention could make the substituting macroblock more similar to the missing macroblock, and could make the whole image more natural by use of replacing missing macroblock by the substituting macroblock in the same object.

### FIELD OF THE INVENTION

The invention relates to a method and device for video coding/decoding, in particular, to a coding/decoding method and device for video error resilient.

### BACKGROUND OF THE INVENTION

In the applications of digital TV (SDTV/HDTV) and multimedia, there are many video compressing standards in order to satisfy various requirements, such as MPEG (Motion Picture Expert Group), H.263 or Quicktime standard. The main purpose of these standards aims to provide a compressed video stream with lower bit rate and better quality.

However, the individual bit errors or bit errors of pulse in the coded video stream (i.e. bit stream errors) will frequently result in loss of the decoder synchronization, which makes it unable to decode until the next synchronization point. Therefore, some parts of the image have reduced quality.

One possible approach to avoid the reduction of image quality is that, to conceal those parts with error on the decoded images by use of error resilience in the decoder. When a conventional video decoder performs error resilience, if some macroblocks in one frame are missed, for the purpose of error resilience, the decoder will create a motion vector and replace the missing macroblock by the region of a reference image which the motion vector points to. In general, the creation of a motion vector could be performed according to the average or median value of the motion vectors of surrounding macroblocks of the missing macroblock.

However, the effect of this error resilience in the decoder is limited. The motion vector of adjacent macroblocks will sometimes have relatively large difference. Thus, the error resilient effect of above-mentioned method is not remarkable. Therefore, it is necessary to have a more efficient coding/decoding method and device which have better error concealment effect.

### OBJECT AND SUMMARY OF THE INVENTION

One aspect of the invention is to provide a coding/decoding method and device for video error resilience. The coding/decoding method and device could make the substituting marcoblocks more similar to the missing original marcoblocks and make the whole image feels more natural after replacing the missing macroblocks by substituting macroblocks.

The coding method for video error resilience according to one embodiment of the invention, includes the steps of: acquiring a piece of macroblock-based object ID information which identifies an object including a macroblock; coding the object ID information into a coded video stream which includes said macroblock.

The decoding method for video error resilience according to one embodiment of the invention includes the steps of: determining a substituting macroblock according to the object ID information of a missing macroblock in a video stream; replacing the missing macroblock by the determined substituting macroblock.

The coding device for video error resilience according to one embodiment of the invention comprises: an acquiring unit, which is configured to acquire a piece of macroblock-based object ID information which identifies an object including a macroblock; a writing unit, which is configured to code the object ID information into a coded video stream which includes said macroblock.

The decoding device for video error resilience according to one embodiment of the invention comprises: a determining unit, which is configured to determine a substituting macroblock according to the object ID information of a missing macroblock in a video stream; a filling unit, which is configured to replace the missing macroblock by the determined substituting macroblock.

In short, since the substituting macroblock is selected from the object which includes the missing macroblock, the object-based coding/decoding method and device according to the invention could ensure the motion vector of substituting macroblock is similar to that of the missing macroblock, such that the effect of error resilience is much better.

These and other aspects and achievements of the invention could be apparent and the invention will be better understood through the following description, the accompanied figures and the claims.

### BRIEF DESCRIPTION OF THE DRAWINGS

FIG. 1 is a flowchart showing the coding method for video error resilience according to one embodiment of the invention;

FIG. 2 shows schematically a piece of object information according to one embodiment of the invention;

FIG. 3 is a flowchart showing the decoding method for video error resilience according to one embodiment of the invention;

FIG. 4 is a structural diagram showing a coding device for video error resilience according to one embodiment of the invention;

FIG. 5 is a structural diagram showing a coding device for video error resilience according to another embodiment of the invention;

FIG. 6 is a structural diagram showing a decoding device for video error resilience according to one embodiment of the invention;

FIG. 7 is a structural diagram showing a decoding device according to one embodiment of the invention.

In all the figures, the same reference numbers indicate the same, similar or corresponding features or functions.

### DETAILED DESCRIPTION OF THE INVENTION

The embodiments of the invention will be described combined with accompanied figures.

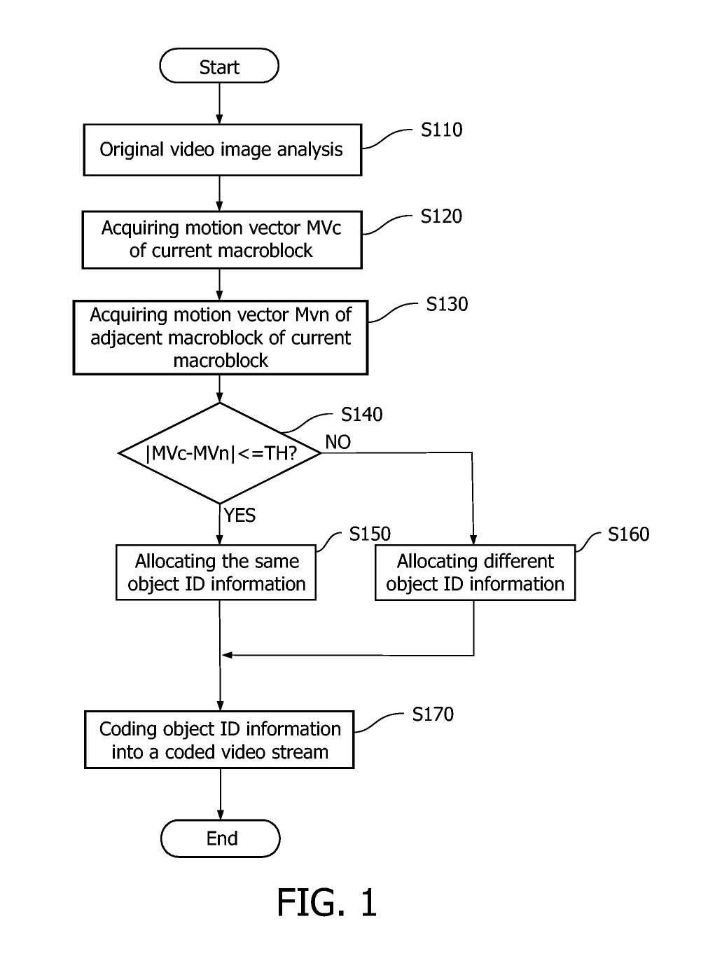

FIG. 1 is a flowchart showing the coding method for video error resilience according to one embodiment of the invention. The coded video stream substantially includes the object ID information corresponding to all of macroblocks by use of the coding method of the invention.

First, in step S110, the video data are coded according to pre-determined standards (such as MPEG, H.263 or Quicktime standard). The original video data are processed to have I frame, P frame and B frame before compressing coding procedure, and arranged into a certain sequence according to parameter setting. Then, the video stream is subjected to DCT transformation, quantization, VLC, motion estimation and motion compensation, the detailed description thereof is omitted.

Wherein, I frame is coded according to the information of the image itself, and the prediction coding of P frame depends on the immediately previous I frame or P frame, that is, the reference frame (such as I frame or P frame) is acquired at first, and performs motion estimation to current frame (such P frame) according to reference frame, then calculate the reference motion vector of current frame. The prediction coding of B frame is depended on itself or the previous and succeeding adjacent frames.

Then, the P frame or B frame is object segmented. First, in step S120, a motion vector (MV_{c}) of current marcoblock in one P frame or B frame is acquired after the Motion Estimation (ES);

Then, in step S130, the motion vector (MVₙ) of the adjacent macroblock of current macroblock is acquired;

In step S140, it is determined that whether the difference of above-mentioned two motion vectors |MV_{c}-MVₙ| is less than or equal to a preset threshold (TH), wherein, the threshold could be preset according to actual application, the less the threshold the higher the accuracy of the object segmentation, generally, it could be set as TH=2 or 3.

Wherein, the above-mentioned motion vector MV includes two components MVₓ and MV_{y} of two directions, when it comes to determine the difference of two motion vectors, it will be performed respectively for each of the component, that is, the macroblocks could be considered as belong to one object only if the values of |MV_{cx}-MVₙₓ| and |MV_{cy}-MV_{ny}| are less than or equal to a preset threshold at the same time.

If the difference of above-mentioned two motion vectors is less than or equal to a preset threshold, the same object ID information will be assigned to current macroblock and adjacent block in step S150.

If the difference of above-mentioned two motion vectors is bigger than a preset threshold, different object ID information will be assigned to current macroblock and adjacent block respectively in step S160.

Finally, in step S170, the acquired object ID information is coded into a coded video stream. In MPEG standard, those assigned object ID information could be coded into private information field of video stream or coded into slice head information of each slice.

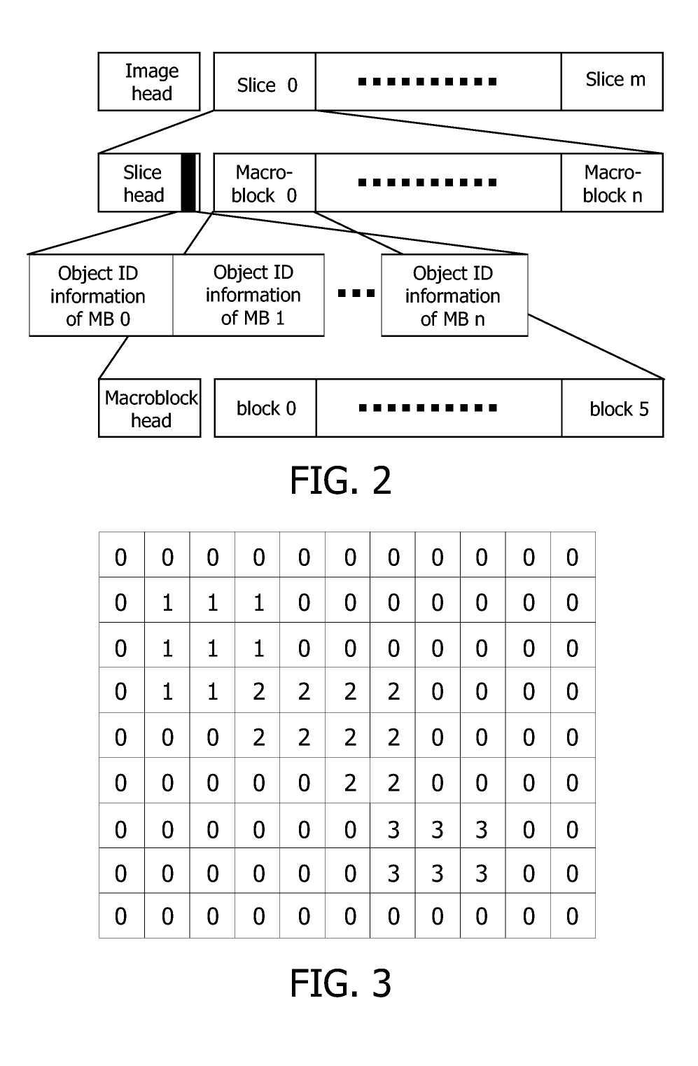

As seen from FIG. 2, the object ID information corresponding to all the macroblocks in one slice are coded into the slice head information of each slice. In MPEG standard, besides those necessary information required by the standard, there is a reserved field in the slice head information field. The other information could be coded into the reserved field when necessary. In the embodiment, the object ID information which use this reserved field to indicate all the macroblocks in the slice are coded into the video stream.

The object ID information is shown in FIG. 3, which is a schematic diagram showing the macroblock-based object ID information according to an embodiment of the invention. The figure shows that one piece of object ID information is generated from macroblocks belonging to the same object. As can be seen from the figure, the image includes four objects in total: the macroblocks of background object are indicated by 0, the macroblocks of other three different objects are indicated by 1, 2, and 3 respectively.

According to another embodiment of the invention, the video image could be object segmented based on pixel, wherein, the pixel-based object segmentation could be converted into macroblock-based segmentation. First, the original video/image data are simplified in order to facilitate the segmentation, wherein, the simplifying process could be performed through low-pass filtering, median filtering, morphological filtering; and the video/image data are subject to feature extraction, wherein, the feature could be color, texture, motion vector, frame difference, displacement frame difference and semantic feature, then the object segmentation is determined according to some kind of uniformity standard. For example, the object segmentation is performed according to whether the difference of pixel values of two adjacent pixels is less than or equal to a preset threshold.

A piece of pixel-based object ID information could be generated from the result of above-mentioned object segmentation on the basis of each pixel, such as the object ID information Flag_{pixel(i,j,n)}=a, (a=1, 2, . . . , N) of pixel (i, j) in the nth frame image, wherein, a is a positive integer from 1 to N.

Then, the pixel-based object ID information is converted into macroblock-based object ID information, such as the additional information Flag_{MB(X,y,n)}=a, (a=1, 2, . . . , N) of macroblock (x, y) in nth frame image, wherein, a is a positive integer from 1 to N, x=INT(i/16), y=INT(j/16). Since a macroblock includes 16×16 pixels, therefore, the coordinates of the macroblock in which each pixel locates could be specified by taking the integral parts of i/16 and j/16.

The Flag_{MB(x,y,n)} is a statistic value, that is, the object ID information of a macroblock equals to the majority of object ID information of the 16×16 pixels included in the macroblock. For example, 70% pixel object ID information in the macroblock indicate Flag=2, and 30% pixel object ID information in the macroblock indicate Flag=3, therefore, the converted object ID information of the macroblock indicates Flag=2. If the numbers of pixels correspond to different object ID information respectively are the same, then either one of the different object ID information could be selected randomly as the object ID information of the macroblock.

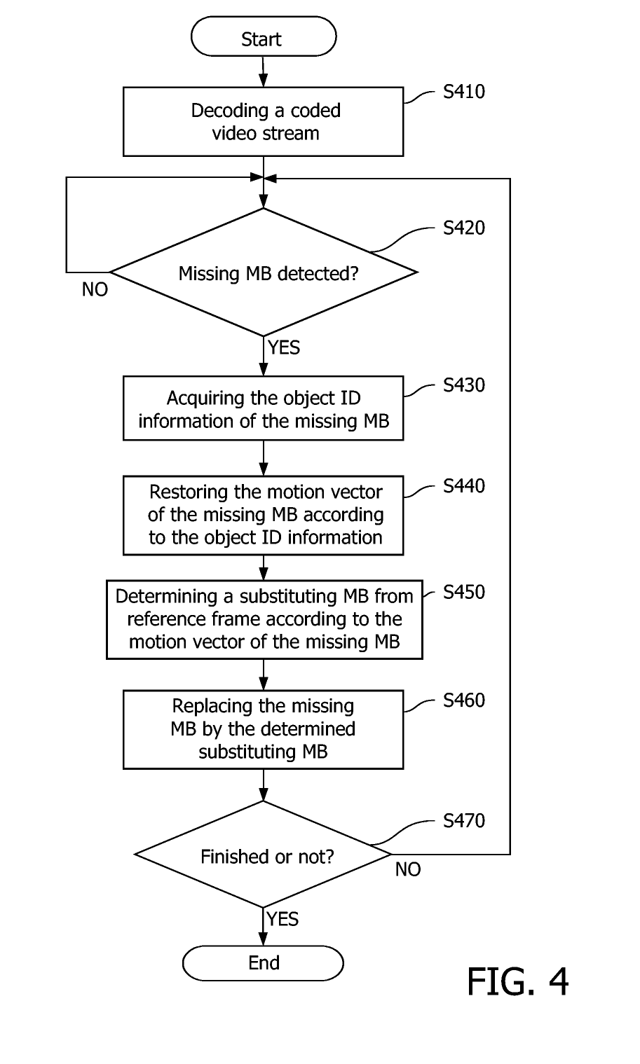

FIG. 4 shows a flowchart of decoding method according to an embodiment of the invention.

First, in step S410, a coded video stream is subject to VLD decoding in order to obtain the code table of variable length coding.

In step S420, a P frame or B frame is detected in order to find whether the P frame or B frame misses any macroblock;

If any missing macroblock is detected in the P frame or B frame, the object ID information which has been pre-coded into the slice head and corresponds to the missing macroblock is acquired in step S430, wherein, the object ID information is used to indicate the object which misses the macroblock, for example, Flag_{(x,y,n)}=2. If no missing macroblock is found after the detection, the procedure goes to step S420 and goes on detecting whether there is any missing macroblock in the next frame.

In the step S440, since the macroblocks of the same object have the same or similar motion vectors, the motion vector of missing macroblock could be restored from the motion vectors of other macroblocks in the same object after acquiring the object ID information of the missing macroblock.

There are various motion vector restoring methods, for example, the motion vector of a missing macroblock could be restored from the average value of motion vectors of all the macroblocks in the same object, also, it could be restored from a median value of motion vectors of all the macroblocks in the same object.

In step S450, a substituting macroblock which the motion vector points to could be determined from a reference frame (such as I frame or P frame) after restoring the motion vector of a missing macroblock.

In step S460, the missing macroblock is replaced by the determined substituting macroblock.

Finally, in step S470, it is determined whether the decoding is finished. If the decoding is not finished, then go back to step S420 and go on detecting whether there is any missing macroblock in next frame or not. If the decoding is finished, then the whole decoding procedure is finished.

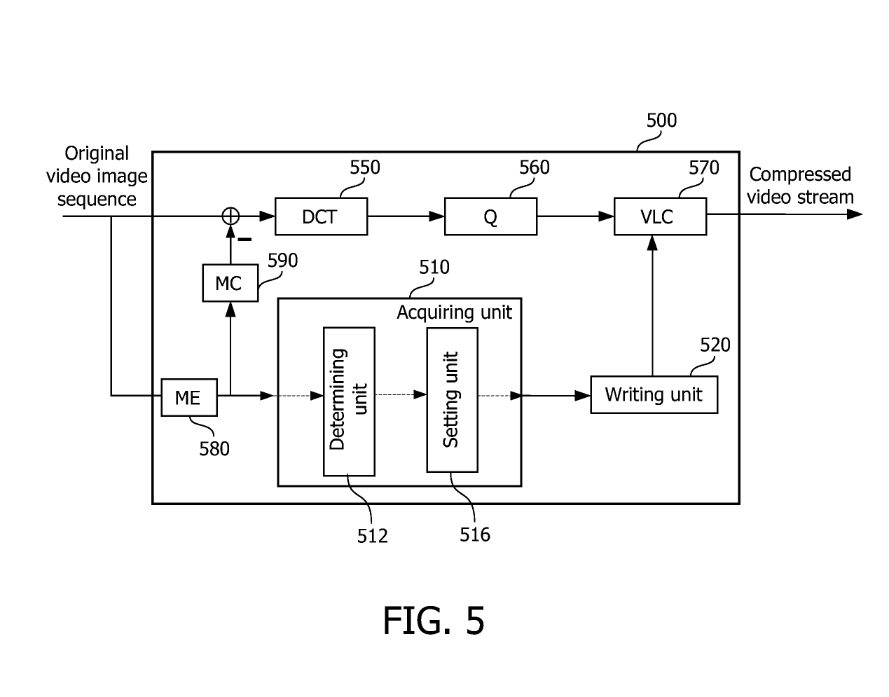

FIG. 5 shows a structural diagram of an object-based error resilience coding device according to an embodiment of the invention.

The coding device 500 includes: an acquiring unit 510 and a writing unit 520. The acquiring unit is configured to acquire object ID information corresponding to each macroblock from original video stream sequence, and the writing unit 520 is configured to code said object ID information into a coded video stream.

According to one embodiment of the invention, the acquiring unit 510 includes a determining unit 512, and may further include a setting unit 516. When the coding of each image according to predetermined standard is finished, the determining unit 512 determines whether the difference of the motion vector of current macroblock and that of adjacent macroblock |MV_{c}-MVₙ| is less than or equal to a preset threshold.

The setting unit 516 could be used for setting object ID information, wherein, the object ID information is set according to the result from determining unit 512. For example, the object ID information could be a one-bit-long flag value. The object ID information of two macroblocks could be set to have the same value (such as 1), if the difference of motion vectors of the two macroblocks |MV_{c}-MVₙ| is less than or equal to a preset threshold, otherwise, the two pieces of object ID information of two macroblocks are set to have different values (such as 1 and 2) respectively.

Then, according to one embodiment of the invention, the writing unit 520 codes all of the object ID information (i.e. the object ID information corresponding to the object which includes the macroblock) into a video stream. For example, the object ID information of all of the macroblock in each slice of the video stream are coded into slice head field of the slice successively, then the coding of image is finished. In above-mentioned descriptions, the writing unit 520 writes the object ID information into a compressed video stream, but those skilled in the art could appreciate that the writing unit 520 could also be included in a variable length coding device 570.

The coding device 500 further includes a discrete cosine transformation device (labeled as DCT for short in the figure) 550, a quantizer (labeled as Q for short in the figure), a variable length coding device (labeled as VLC for short in the figure) 570, a motion estimation device (labeled as ME for short in the figure) 580, and motion compensation device (labeled as MC for short in the figure) 590.

Wherein, the discrete cosine transformation device 550 receives original video image sequence and performs discrete cosine transformation. The quantizer 560 sets different quantization levels according to different requirements for the resultant DCT coefficient in order to lower the bit rate. However, after the quantization, in particular, the quantization which sets low frequency components and high frequency components differently depending on the physiological features of human eyes, most of the coefficients of high frequency components become zero. In general, human's eyes are more sensitive to low frequency components and less sensitive to high frequency components. Therefore, the quantization for low frequency components is carried out at fine frequency intervals and the quantization for high frequency components is carried out at large frequency intervals.

The variable length coding device 570 converts the quantization coefficient from quantizer into variable length code (such as Huffman code) depending on the quantization amplitude of quantizer 560, in order to lower the bit rate.

The motion estimation device 580 acquires reference frame (such as P frame or I frame) from frame memory (not shown) and performs motion estimation to current frame (such as P frame) according to reference frame, in order to obtain the reference motion vector of current frame. The acquiring unit 510 will acquire object ID information corresponding to each macroblock according to the reference motion vector. The motion compensation device 590 shifts the reference frame correspondingly according to estimation type and the reference motion vector, in order to estimate current frame. Since the estimation procedure is similar to prior art, the detail thereof will not be explained.

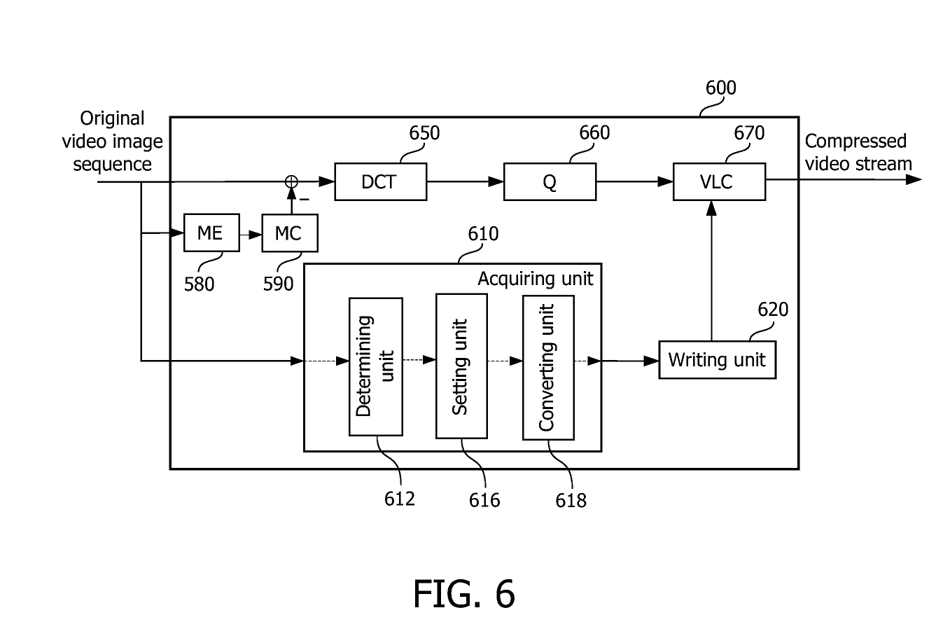

FIG. 6 shows the schematic structural diagram of an object-based error resilient coding device according to another embodiment of the invention. According to another embodiment of the invention, the video image could be object-segmented based on pixel. The pixel-based object segmentation could be converted into macroblock-based segmentation.

The coding device 600 comprises an acquiring unit 610 and a writing unit 620. The acquiring unit 610 is configured to acquire object ID information corresponding to each macroblock from original video stream sequence, and the writing unit 620 is configured to code said macroblock-based object ID information into a coded video stream.

The acquiring unit 610 includes a determining unit 612, and may further include a setting unit 616 and a converting unit 618. The determining unit 612 performs object segmentation to original video images based on pixel. The determining unit 612 determines whether at least one feature value (such as pixel value, color or texture) of two adjacent pixels is less than or equal to a preset threshold. The setting unit 616 could be used for setting object ID information, wherein, the object ID information is set according to the result from determining unit 612. For example, the object ID information could be a one-bit-long flag value. The object ID information of two adjacent pixels could be set to have the same value (such as 1) if the difference of at least one feature value (such as color, texture etc.) of two adjacent pixels is less than or equal to a preset threshold, otherwise, the object ID information of two pixels could be set to be different values (such as 1 and 2) respectively.

The pixel-based object ID information could be generated from above-mentioned object segmentation for each pixel. For example, the object ID information of pixel (i, j) of the nth frame image Flag_{pixel(i,j,n)}=a, (a=1,2, . . . N), wherein, a is an positive integer from 1 to N.

The converting unit 618 converts the above mentioned pixel-based object ID information into macroblock-based object ID information, such as the additional information of macroblock (x, y) of the nth frame image Flag_{MB(X,y,n)}=a,(a=1,2, . . . N), wherein, a is an positive integer from 1 to N, and x=INT(i/16), y=INT(j/16).

Then, the writing unit 620 codes all the macroblock-based object ID information (i.e. the ID information corresponding to the object which includes the macroblock) into a video stream. For example, the object ID information of all the macroblocks in each slice of the video stream are coded into slice head field of the slice successively, then the coding of the image is finished.

The coding device 600 further includes a discrete cosine transformation device (labeled as DCT for short in the figure) 650, a quantizer (labeled as Q for short in the figure), a variable length coding device (labeled as VLC for short in the figure) 670, a motion estimation device 580, and motion compensation device 590. Since the functions of these units are similar to that of corresponding units in FIG. 5, the explanations thereof are omitted.

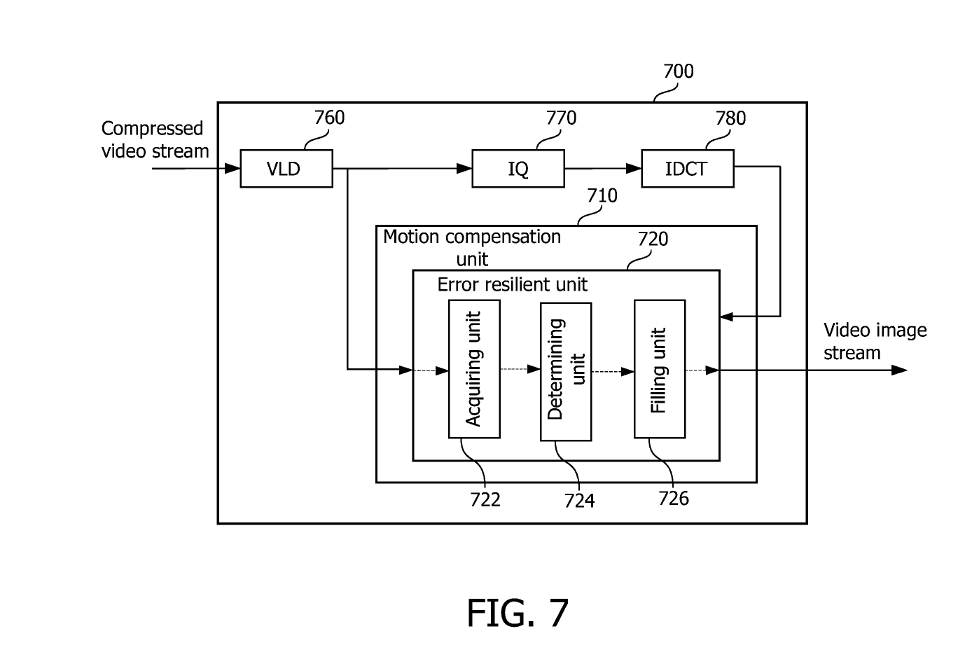

FIG. 7 is a schematic structural diagram of a decoding device according to one embodiment of the invention. The decoding device 700 includes: a motion compensation unit 710, which is configured to reduce the time redundancy by use of the correlation between frames. Since the motion compensation is not inherently related with the invention, the details of motion compensation are not explained.

The motion compensation unit 710 includes an error resilient unit 720, which could determine a substituting marcoblock to replace a missing marcoblock with. The error resilient unit 720 includes an acquiring unit 722, which is configured to acquire the object ID information of a missing marcoblock. The object ID information is written into a video stream during coding the video image by the coding device.

The error resilient unit 720 may further include a determining unit 724, which is configured to determine a substituting macroblock. Since the macroblocks of the same object have the same or similar motion vectors, the motion vector of the macroblocks in the same object could be used for restoring the motion vector of missing macroblock according to the object ID information acquired by acquiring unit 722. Then, a substituting macroblock which the motion vector points to is determined from a reference frame (such as I frame or P frame) according to the restored motion vector of the missing macroblock.

The error resilient unit 720 may further include a filling unit 726, which is configured to fill the position of a missing macroblock with a determined substituting marcoblock.

The decoding device 700 may further include a variable length decoding device (labeled as VLD for short in the figure) 760, an inversed quantizer (labeled as IQ for short in the figure) 770, an inversed discrete cosine transformation device (labeled as IDCT for short in the figure) 780. The decoding functions thereof correspond to those of variable length coding device 770, quantizer 560 and discrete cosine transformation device 750 in the coding device 700 of FIG. 5, respectively, and the explanations thereof are omitted.

The acquiring unit 722 acquires the object ID information of a missing marcoblock after the variable length decoding unit 760 decoding the compressed video stream. After acquiring the object ID information of the missing macroblock, since the macroblocks of the same object have the same or similar motion vectors, the motion vectors of the macroblocks in the same object could be used for restoring the motion vector of the missing macroblock by determining unit 724 according to the object ID information.

After restoring the motion vector of the missing macroblock, the determining unit 724 determines a substituting macroblock which the motion vector points to from a reference frame (such as I frame or P frame) according to the restored motion vector of the missing macroblock.

Then the filling unit 726 fills the position of the missing macroblock by the determined substituting marcoblock. Finally, the error-resilient video image sequence is output and present to the user by a display device (not shown).

It will be appreciated by those skilled in the art that the coding/decoding method and device of video error resilience of the invention could be modified without departing from the scope of the invention. Therefore, the scope of protection should be limited by the content of appended claims.

1. A coding method for video error resilience, including the steps of:
(a) acquiring a piece of macroblock-based object ID information, wherein, the object ID information is used for identifying an object in which the macroblock locates;
(b) coding the piece of object ID information into a coded video stream, wherein, the coded video stream includes the macroblock.

2. The method according to claim 1, wherein, the step (a) including the steps of:
determining if the macroblock and one of adjacent macroblocks belong to the same object; setting corresponding object ID information to the macroblock according to a result of the determining.

3. The method according to claim 2, wherein, the determining step including the step of:
determining if a difference of motion vectors of the macroblock and the one of adjacent macroblocks is less than a threshold.

4. The method according to claim 1, wherein, the step (a) including the steps of:
determining if a difference of a feature value of a pixel and one of adjacent pixels included in the macroblock is less than a threshold;
setting a piece of pixel-based object ID information to the pixel according to a result of the determining;
converting the pixel-based object ID information into the macroblock-based object ID information.

5. A decoding method for video error resilience, including the steps of:
determining a substituting macroblock according to object ID information of a missing macroblock in a video stream;
replacing the missing macroblock by the determined macroblock.

6. The method according to claim 5, further including the step of:
acquiring an object ID information, wherein, the object ID information is used to identify an object in which the missing macroblock locates.

7. A coding device for video error resilience, comprising:
an acquiring unit, which is configured to acquire macroblock-based object ID information, wherein, the object ID information is used to identify an object in which a macroblock locates;
a writing unit, which is configured to code the object ID information into a coded video stream, wherein, the coded video stream includes the macroblock.

8. The device according to claim 7, wherein, the acquiring unit comprising:
a determining unit, which is configured to judge if the macroblock and one of its adjacent macroblocks belong to the same object;
a setting unit, which is configured to set corresponding object ID information to the macroblock according to a result of the determining.

9. The device according to claim 8, wherein, the determining unit is used to judge if a difference of motion vectors of the macroblock and the one of its adjacent macroblocks is less than a threshold.

10. The device according to claim 7, wherein, the acquiring unit comprising:
a determining unit, which is configured to judge if a difference of a feature value of a pixel and one of its adjacent pixels included in the macroblock is less than a threshold;
a setting unit, which is configured to set corresponding object ID information to the pixel according to a result of the determining;
a converting unit, which is configured to convert the pixel-based object ID information into the macroblock-based object ID information.

11. A decoding device for video error resilience, comprising:
a determining unit, which is configured to determine a substituting macroblock according to object ID information of a missing macroblock in a video stream;
a filling unit, which is configured to replace the missing macroblock by the determined substituting macroblock.

12. The device according to claim 11, further comprising:
an acquiring unit, which is configured to acquire object ID information of a missing macroblock in a video stream, wherein, the object ID information is used to identify an object in which the missing macroblock locates.
